(19) United States
(12) Patent Application Publication
(10) Pub. No.: US 2013/0297297 A1
(43) Pub. Date: Nov. 7, 2013

(54) SYSTEM AND METHOD FOR CLASSIFICATION OF EMOTION IN HUMAN SPEECH

(71) Applicant: Erhan GUVEN, Rockville, MD (US)

(72) Inventor: Erhan GUVEN, Rockville, MD (US)

(21) Appl. No.: 13/858,578

(22) Filed: Apr. 8, 2013

Related U.S. Application Data
(60) Provisional application No. 61/643,665, filed on May 7, 2012.

(51) Int. Cl. G10L 15/02

(52) U.S. Cl. CPC G10L 15/02
USPC 704/204

(57) ABSTRACT

A system performs local feature extraction. The system includes a processing device that performs a Short Time Fourier Transform to obtain a spectrogram for a discrete-time speech signal sample. The spectrogram is subdivided based on natural divisions of frequency to humans. Time-frequency-energy is then quantized using information obtained from the spectrogram. And, feature vectors are determined based on the quantized time-frequency-energy information.

### RELATED APPLICATIONS

The present application claims priority to provisional application No. 61/643,665, filed May 7, 2012, the entire contents of which is hereby incorporated by reference.

### BACKGROUND OF THE INVENTION

To achieve greater efficiency of human computer interactions may necessitate the automatic understanding of and appropriate response to a human voice in a variety of conditions. Though the main task involves Automatic Speech Recognition (ASR), Automatic Language Understanding (ALU) and Automatic Speech Generation (ASG), a lesser but important part of the main task is the automatic recognition of the speaker's emotion [1] or Speech Emotion Recognition (SER).

In the last few decades, several studies approached the problem of perception of emotions focused on different aspects of the task. These included uncovering the acoustic features of emotional speech, techniques to extract these features, suitable methods of discrimination and prediction, and hybrid solutions such as combining acoustic and linguistic features of speech. Some of these previous studies, using different feature extraction methods, reported performance measures from several speech emotion recognition experiments, which were limited to the subsets of emotions represented in the few available emotional-speech databases created by voice actors. In their work Scherer [2] achieved 66% average classification accuracy for 5 emotions; Kwon [3] achieved 70% average accuracy for 4 emotions; Yu [4] achieved 85% average accuracy for 4 emotions.

There are other studies which use hybrid (multimodal) methods to try to improve emotion prediction by including information from other sources such as linguistics and multistage predictors. For example, Sidorova [5] achieved 78% average accuracy for 7 emotions using additional linguistic features of the speech; Liu [6] achieved 81% and 76% average accuracies for 6 emotions for males and females, respectively. Clearly, the reported performances do not come close to a perfect classification; which compares favorably with the fact that even humans have difficulty in recognizing emotions from the same speech emotion databases. In a recent study Dai [7] reported that only 64% of the estimates made by humans matched the labels in the emotional speech database of 8 actors and 15 emotions published by the Linguistic Data Consortium.

In the literature, it is widely accepted that the global features of the speech signal are more useful than the time-local features [8]. Hence, all previous studies used global features extracted from the acoustic and the frequency spectra, such as duration, pitch, energy contours, etc. In general, one feature vector per utterance is generated and passed to a learning method.

High level music and speech features (i.e. timbre, melody, bass, rhythm, pitch, harmony, key, structure, lyrics) are hard to extract [17] and outperformed by the methods that employ low level audio features [17] which are measurements from the audio signal. Signal processing techniques such as Short Time Fourier Transform (STFT), constant-Q/Mel spectrum, pitch chromagram, onset detection, Mel-Frequency Cepstral Coefficients (MFCC), spectral flux, tempo tracking are among the many ways that are proposed to extract low level music features [18]. Though these low level features are considered to be more useful in general, the low precision, poor generalization, and loose coupling (to the underlying music aspect, timbre, melody, rhythm, pitch, structure, lyrics, etc.) of low level features make it a necessity to employ a second stage processing that can relate the low level features of the music to its content [18].

However, in previous studies conducted by the authors [9], a sequential set of overlapping feature vectors were generated for each utterance and passed to a statistical classifier. In addition, these feature vectors were devised based on knowledge of the human auditory system by taking into account the time-frequency information and the sensitivity to the frequency bands of the Bark scale [10]. Extracting local features makes it possible to employ secondary processing such as a second-stage statistical classifier. In this study, a simpler second-stage process of majority voting is shown to improve the accuracy and robustness of the end-to-end classification performance.

The SER method used in this study extracts several features from a narrow time-slice of spectrogram and assembles them into feature vectors to train a Support Vector Machine (SVM) [11] with a Radial Basis Function (RBF) kernel after which the result hyperplane can be used to classify the emotions of unknown feature vectors. In order to measure the classification performance, a 5-fold cross-validation protocol is repeated to achieve a sufficient statistical, based on random samples of 1) the German emotional database (EMO) [12,13] and 2) the emotional prosody speech database from the Linguistic Database Consortium (LDC) [14,15].

Sound is the vibration of air molecules, and hearing takes place when these vibrations are transferred mechanically to the sensory hair cells in the cochlea in the human ear. As different cells and their placement in the inner ear react to different frequencies, both the energy and the associated frequency of these vibrations are identified by these cells. The scale of the frequency response of these cells can be measured according to the psycho-acoustical Bark scale proposed by Eberhard Zwicker in 1961 [10].

The cochlea measures the power of the sound as a function of its frequency with its sensory hair cells that respond differently to distinct frequencies [10]. The sensitivity of the cochlea with respect to different frequencies is modeled by the Bark Scale. It is possible to construct a digital signal processing pipeline which is computationally equivalent to the cochlea. First, a Short Time Frequency Transform (STFT) of the speech is computed, which represents the raw time-frequency-power information (a spectrogram) that is analogous to the progressive sensory output of the cochlea. Second, the output of the STFT is quantized by Bark Scale filters into bins, which cover the complete frequency range from 20 Hz to 7700 Hz. Finally, linear regression coefficients of the time-frequency-power surface can be determined [9]. This corresponds to average power per bin over a given time slot, the slope of the power parallel to the time axis, and the slope of the power parallel to the frequency axis for each bin and time slot. At each time slot, these features are assembled to form the feature vectors for the learning algorithm described in [3].

In signal processing, the Fourier Transform (FT) of a signal represents the distribution of the energy of that signal at different frequencies. Since the Fourier basis is sinusoidal with infinite duration, it gives very little information about the time localization. A local artifact, for example, can be represented much better with a Dirac-delta function rather than a Fourier basis, but the delta function will yield almost no information about the frequency content of the artifact, and it may be exactly this information which characterizes different underlying emotions. Therefore, applying the Short Time Fourier Transform (STFT) over a window at each time step may be a more useful approach. Since the cochlea is a mechanical time-frequency analyzer, it is constantly sensing a short sequence of slightly time-shifted spectra of the speech signal, which is approximately what happens when an STFT is applied to the signal.

However, there are limitations to an STFT of a signal: the time and the frequency resolutions are fixed throughout the transform. A narrow window yields better time resolution but poorer frequency resolution, and a wide window yields the opposite. This property is also called the time-frequency uncertainty of the STFT. To model the frequency response of the human ear as accurately as possible, the feature extraction method can use the Bark scale quantization, and then the time resolution and other feature extraction parameters are varied to maximize the performance of the statistical classifier.

The following documents are hereby incorporated by reference: (1) R. W. Picard, Affective Computing, MIT Press, 1997; (2) K. R. Scherer, “A cross-cultural investigation of emotion inferences from voice and speech: Implications for speech technology,” Proc. of Int. Conf. on Spoken Lang. Processing, Beijing, China, 2000; (3) 0. Kwon, K. Chan, J. Hao, and T. W. Lee, “Emotion recognition by speech signals,” Proceedings of Eurospeech, 2003, pp. 125-128; (4) C. Yu, and Q Tian, “Speech emotion recognition using support vector machines,” Springer, 2011; (5) J. Sidorova, “Speech emotion recognition with TGI+.2 classifier,” Proc. of the EACL Student Research Workshop, 2009, pp. 54-60; (6) J. Liu, et al., “Speech emotion recognition using an enhanced co-training algorithm,” Proc. ICME, Beijing, 2007, pp. 999-1002; (7) K. Dai, H. Fell, and J. MacAuslan, “Comparing emotions using acoustics and human perceptual dimensions,” Conf. on Human Factors in CS. 27th Int. Conf, 2009, pp. 3341-3346; (8) B. Schuller, et al., “Hidden Markov Model-Based Speech Emotion Recognition,” Proc. ICASSP 2003, Vol. II, Hong Kong, pp. 1-4; (9) E. Guven, and P. Bock, “Recognition of emotions from human speech,” Artificial Neural Networks. In Engineering, St. Louis, 2010, pp. 549-556; (10) E. Zwicker, “Subdivision of the audible frequency range into critical bands,” The Jour. of the Acous. Soc. of America, 33, 1961; (11) C.-C. Chang, and C.-J. Lin, LIBSVM. a Library for Support Vector Machines, 2001. Software available at http://www.csie.ntu.edu.tw/˜cjlin/libsvm; (12) F. Burkhardt, A. Paeschke, M. Rolfes, W. Sendlmeier, and B. Weiss, “A database of German emotional speech,” Proceedings of the Interspeech, Lisbon, Portugal, 2005, pp. 1517-1520; (13) Berlin Database of Emotional Speech. http://pascal.kgw.tu-berlin.de/emodb/index-1280.html. 28 March, 2012; (14) M. Liberman, Emotional prosody speech and transcripts, Linguistic Data Consortium, Philadelphia, 2002; (15) Emotional Prosody Speech and Transcripts. http://www.ldc.upenn.edu/Catalog/CatalogEntry.jsp?catalogId=LDC2002S28. 28 Mar., 2012; (16) Paliwal, K., and Alsteris, L., “Usefulness of phase spectrum in human speech perception,” Eurospeech 2003, Geneva, Switzerland, pp. 2117-2120; (17) Casey, M., et. al., “Content-based music information retrieval: current directions and future challenges”, Proc. IEEE, 96(4):668-696, 2008; (18) Fu, G., et. al., A survey of audio-based music classification and annotation, IEEE Trans. on Multimedia, 13(2):303-319, 2011; “Recognition of Emotions from Human Speech,” Artificial Neural Networks In Engineering (ANNIE), October 2010, St. Louis, Mo.; “Speech Emotion Recognition using a Backward Context,” IEEE Applied Imagery Pattern Recognition (AIPR) Workshop, December 2010, Washington D.C.; Note and Timbre Classification by Local Features of Spectrogram,” Complex Adaptive Systems, November 2012, Washington D.C.

### SUMMARY OF THE INVENTION

A system performs local feature extraction. The system includes a processing device that performs a Short Time Fourier Transform to obtain a spectrogram for a discrete-time speech signal sample. The spectrogram is subdivided based on natural divisions of frequency to humans. Time-frequency-energy is then quantized using information obtained from the spectrogram. And, feature vectors are determined based on the quantized time-frequency-energy information.

In addition, the step of subdividing the spectrogram comprises subdividing the spectrogram is based on the Bark scale. Majority voting can be employed on the feature vectors to predict an emotion associated with the speech signal sample. Weighted-majority voting can also be employed on the feature vectors to predict an emotion associated with the speech signal sample.

### BRIEF DESCRIPTION OF THE FIGURES

FIG. 1 is a software architecture that implements the Speech Emotion Recognition;

FIG. 2 is a process for feature extraction from speech sample using SER method;

FIG. 3 is a weighted majority voting scheme;

FIG. 4 is a segmentation of the spectrogram using Bark scale on the frequency and SER designer parameters on the time axis; and

FIG. 5 is a demonstration of the SER method on a flute sound clip.

### DETAILED DESCRIPTION OF THE INVENTION

In describing the preferred embodiments of the present invention illustrated in the drawings, specific terminology is resorted to for the sake of clarity. However, the present invention is not intended to be limited to the specific terms so selected, and it is to be understood that each specific term includes all technical equivalents that operate in a similar manner to accomplish a similar purpose.

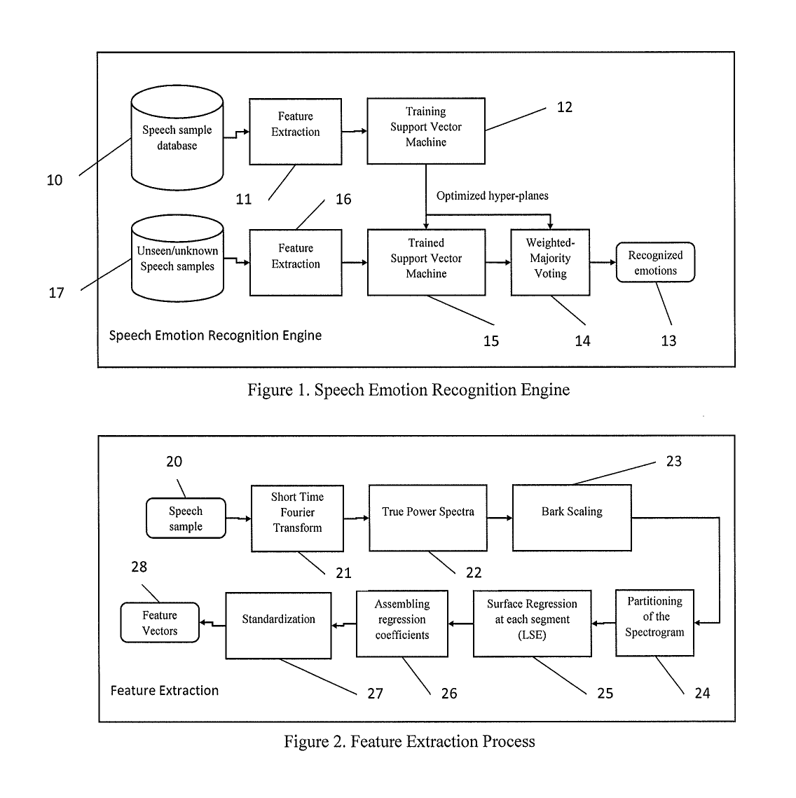

FIG. 1 shows a speech sample database (10) that feeds the feature extraction module (11) with speech samples. A Support Vector Machine (12) is used to train the feature vectors generated by (11). Element (12) also generates the optimized hyper-planes to be passed to elements (14) and (15). The speech database (17) contains previously unknown/untested/unseen speech sample which is to be predicted of emotions. A similar feature extraction element (16) uses the data from (17) and passes to element (15) which is a trained SVM, which uses the hyper-planes from (12). Element (15) outputs the predicted labels to be used by element (14). Element (14) is a weighted-majority voting module which uses the hyper-plane information from element (12). The output of (14) is the prediction emotion labels of the speech sample that was fed to the system by element (17). Element (13) are the predicted emotion labels of the speech sample that was fed to the system by element (10). Element (13) can be any means of emotion detection indicator such as a computer display, a buzzer, an alarm, a database, or an output to be used by the next system that makes use of the predicted emotion labels.

FIG. 2 illustrates the feature exaction process of FIG. 1. Both element (11) and (16) of FIG. 1 implements the process explained in FIG. 2. Here, a speech sample (20) is fed to element (21) which calculates the Short Time Fourier Transform of the speech signal. Element (22) takes the STFT and calculates the true power spectra and feeds it to the partitioning module for Bark scaling (23). Element (24) further partitions the STFT output on the time-axis and passes to element (25) for surface linear regression to be computed. Element (26) assembles the regression coefficients from (25) and passes to (27) for standardization. (27) Output represents the feature vectors to be used for training and testing on the SVM.

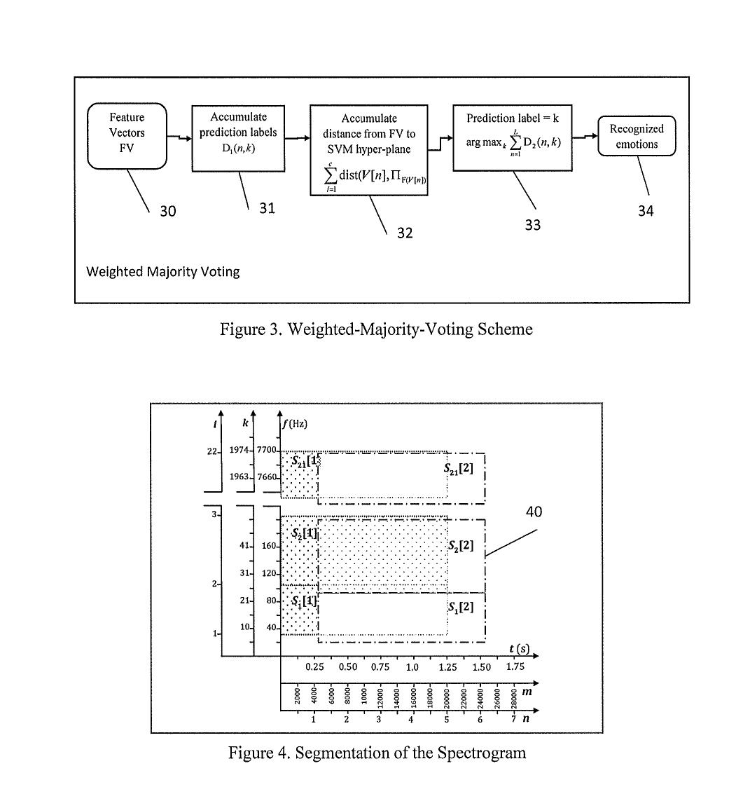

Turning to FIG. 3, the weighted-majority-voting of element (14) in FIG. 1 is shown in further detail. Here, element (30) retains the feature vectors generated by a trained SVM and passes to element (31) to accumulate the prediction labels consecutively as they are generated. Element (32) accumulates the prediction labels and the hyper-planes from trained SVM to compute the distances of each feature vector to the respected hyper-plane grouped by the predicted labels. Element (33) accumulates the output of the (32) to make a decision on the final prediction label. And element (33) outputs the predicted labels to be collected by element (34).

At FIG. 4, element (40) represents the segmentation of the spectrogram where f_{S}=16000 Hz, f_{R}=3.9063 Hz, t_{R}=0.25 s, n_{TS}=5. The labels of the axes t as time in seconds versus f as frequency in Hz; k as the discrete time index versus m as the spectrogram frequency index; i as the Bark scale band index versus n as the time slot index.

In the Speech Emotion Recognition method of the present invention, the extracted features are assembled into feature vectors to train a Support Vector Machine (SVM) classifier (15) after which it can be used to classify the emotions of unknown feature vectors (16), FIG. 2. A speaker-independent leave-one-out experiment was used to validate the effectiveness of the SER method applied to the German emotional database of 535 utterances by 10 speakers (5 male, and 5 female) of 7 emotions (neutral, happy, sad, angry, disgust, fear, and boredom) and applied to LDC database of 619 utterances by 3 male and 4 female speakers in English language in 15 emotions (neutral, happy, sad, angry, disgust, fear, boredom, cold anger, contempt, despair, elation, interest, panic, pride, and shame).

The feature extraction starts with a spectrogram of the discrete time speech signal x[n] sampled at a frequency of f_{S}, and a segmentation of the spectrogram by means of Bark scale and user-set time-axis parameters. Given a set of three parameters, frequency resolution f_{R}, time resolution t_{R}, number of time slots n_{TS} and a window function w[n], calculate the true power spectra S[k,n] in decibels as in the following.

$$\begin{matrix}X [ k , n ] = {\sum }_{m = 0}^{N - 1} x [ m - ⌈ {f}_{S} {t}_{R} - 0.5 ⌉ n ] w [ m ] {e}^{- i2 π \frac{km}{N}} , \\ where N = ⌈ {f}_{S} / {f}_{R} ⌉ & ( 1 ) \\ S [ k , n ] = \frac{1}{{f}_{S} w {w}^{T}} 10 log {\vert X [ k , n ] \vert}^{2} & ( 2 )\end{matrix}$$

Choose a suitable f_{R} resulting a window length N in powers of 2, so that the Fast Fourier Transform (FFT) can be computed efficiently. Segment S[k,n] by Bark scale to get Sᵢ[n], then calculate surface linear regression coefficients of Sᵢ[n] in order to assemble the feature vectors V[n].

Assuming f_{S}>7700 Hz and using the constant Bark scale (Hz) vector B_{S}=[20 100 200 300 400 510 630 770 920 1080 1270 1480 1720 2000 2320 2700 3150 3700 4400 5300 6400 7700]^{T}, calculate the index vector B,

$$B = {[ {b}_{i} ]}_{r} = ⌈ \frac{1}{{f}_{R}} {B}_{S} + 1 ⌉ r = \vert {B}_{S} \vert - 1 \qquad ( 3 )$$

Partition the power spectra S[k,n] matrix into Sᵢ[n] matrices for i=1, . . . , r,

$$\begin{matrix}{S}_{i} [ n ] = \{ S [ k , m ] \text{:} {b}_{i} \leq k < {b}_{i + 1} n \leq m < n + {n}_{TS} \} & ( 4 ) \\ {S}_{i} [ n ] = [ \begin{matrix}{S}_{{b}_{i} , n} & {S}_{{b}_{i} , n + 1} & … & {S}_{{b}_{i} , n + {n}_{TS} - 1} \\ {S}_{{b}_{i} + 1 , n} & {S}_{{b}_{i} + 1 , n + 1} & … & {S}_{{b}_{i} + 1 , n + {n}_{TS} - 1} \\ ⋮ & ⋮ & ⋱ & ⋮ \\ {S}_{{b}_{i + 1} - 1 , n} & {S}_{{b}_{i + 1} - 1 , n + 1} & … & {S}_{{b}_{i + 1} - 1 , n + {n}_{TS} - 1}\end{matrix} ] & ( 5 )\end{matrix}$$

As an example, consider a speech signal sampled at a sampling frequency f_{S} of 16000 Hz. Given the feature extraction variables f_{R}, t_{R}, and, n_{TS}, set as 3.9063 Hz, 250 ms and, 5, respectively. See FIG. 4. This variable setting yields the intermediate parameters N and M as 4096 and 4000, respectively. Please note that, the intermediate parameter N is constrained to be in powers of 2, to meet the requirement of the Fast Fourier Transform (FFT) algorithm which is an efficient implementation of the Discrete Fourier Transform (DFT) as in the summation in (1).

After S[k,n] is generated as in (8), the frequency and time axes are partitioned into segments by mapping the discrete frequency k to the Bark scale band B and a predetermined and fixed time t_{R} (time resolution). Each segment Si[n] of the spectrogram is defined by equation (5). The optimal quantization plane of each segment S₁[n] represented by Y is computed using multiple-linear regression as in the following.

Given a Sᵢ[n] matrix with size [q×p], at each Bark scale partition i and the time-slot n, calculate the regressed frequency-time surface at the center of the partition,

S=Sᵢ[n]εR^{q}×R^{p} (6)

Y=aF+bT+c+E a,b,cεR; Y,F,T,EεR^{qp} (7)

Y_{[qp×1]}=X_{[qp×3]}Z_{[3×1]}+E_{[qp×1]} (8)

Setting the regression surface origin at the center of the partition,

$$\begin{matrix}Y = [ \begin{matrix}{S}_{1 , 1} \\ {S}_{1 , 2} \\ ⋮ \\ {S}_{p} \\ {S}_{2 , 1} \\ {S}_{2 , 2} \\ ⋮ \\ {S}_{q , p}\end{matrix} ] X = [ \begin{matrix}- ⌊ \frac{q}{2} ⌋ & - ⌊ \frac{p}{2} ⌋ & 1 \\ - ⌊ \frac{q}{2} ⌋ & - ⌊ \frac{p}{2} ⌋ + 1 & 1 \\ ⋮ & ⋮ & ⋮ \\ - ⌊ \frac{q}{2} ⌋ & - ⌊ \frac{p}{2} ⌋ + p & 1 \\ - ⌊ \frac{q}{2} ⌋ + 1 & - ⌊ \frac{p}{2} ⌋ & 1 \\ - ⌊ \frac{q}{2} ⌋ + 1 & - ⌊ \frac{p}{2} ⌋ + 1 & 1 \\ ⋮ & ⋮ & ⋮ \\ - ⌊ \frac{q}{2} ⌋ + q & - ⌊ \frac{p}{2} ⌋ + p & 1\end{matrix} ] & ( 9 ) \\ Z = [ \begin{matrix}a \\ b \\ c\end{matrix} ] E = [ \begin{matrix}{ɛ}_{1} \\ {ɛ}_{2} \\ ⋮ \\ {ɛ}_{p} \\ {ɛ}_{p + 1} \\ {ɛ}_{p + 2} \\ ⋮ \\ {ɛ}_{qp}\end{matrix} ] & ( 10 ) \\ Y = X Z + E {\to }^{least square estimates } \hat{Z} = {( {X}^{T} X )}^{- 1} {X}^{T} Y & ( 11 )\end{matrix}$$

After computing the estimated regression coefficients \hat{Z} of Sᵢ[n] for i=1, . . . , r, assemble the feature vector V[n],

V[n]=[a_{1,n} b_{1,n} c_{1,n} a_{2,n} . . . b_{r,n} c_{r,n}]^{T}, where r=|B_{S}|−1 (12)

The Bark scale is modified to include segments centered at frequencies of music notes ranged from C4 to C5.

B_{S}=[20 100 200 254 269 285 302 320 339 360 381 404 428 453 480 509 539 630 770 920 1080 1270 1480 1720 2000 2320 2700 3150 3700 4400 5300 6400 7700]^{T} (13)

In addition, two more features, corresponding to first and second formants, are calculated directly from the segmented spectrogram and added to the feature vector.

Vᵣ₊₁[n]=max{c_{i,n}}, i=1, . . . ,r and Vᵣ₊₂[n]=max{{c_{i,n}}−Vᵣ₊₁[n]}, i=1, . . . ,r (14)

Given a set of training data points X and categories Y for each of the given data point.

X={x₁,x₂, . . . , xₘ}, xᵢεRⁿ; Y={y₁, y₂, . . . , yₘ}, yᵢεΣ; Σ={w₁, w₂, . . . ,w_{c}}, wᵢεZ (15)

There are two major reasons for picking the SVM as the classifier in this method. First, SVMs are not affected negatively by low number of data points when the attributes are high in number (curse of dimensionality), because they are designed to divide the space into partitions according to the category labels of the data points. Second, SVMs (also known as large-margin classifiers) avoid over-fitting the model to the data, as the margin distance between the support vectors and the imaginary hyperplane is expected to be maximized at the end of the SVM training. Since the generated feature vectors are high dimensional (98 numerical attributes) and low in number (generated every 0.05 seconds or more), SVM is among the natural best classifier options in this method. Nevertheless, in pilot studies, several classifiers from the Weka package such as Naive Bayes, C4.5 decision trees, and nearest neighbor programs were greatly outperformed by the SVM program.

The multi-class SVM maximizes the distances between the points belonging to category pairs {wᵢ, wⱼ} to the corresponding dividing hyperplane Πᵢⱼ, where i≠j. winner-takes-all decision function F is the following.

$$F ( x ) = {w}_{k} ⇔ k = arg {max}_{k} {\sum }_{j = 1}^{c} sgn ( dist ( x , {Π}_{kj} ) ) \qquad ( 16 )$$

After each feature vector is labeled with the predicted category by the decision function F(x), a majority voting decision function G₁(V) takes place to decide the final category of the discrete-time signal of length L.

$${D}_{1} ( n , k ) = \{ \begin{matrix}1 & if k = F ( V [ n ] ) \\ 0 & otherwise\end{matrix} \\ {G}_{1} ( V ) = {w}_{k} ⇔ k = arg {max}_{k} {\sum }_{n = 1}^{L} {D}_{1} ( n , k ) \qquad ( 17 )$$

This decision mechanism can be further improved by taking into account the actual distance values which are already computed by the multiclass SVM for each feature vector and hyperplane. Define the distance-weighted majority voting decision function G₂(V) as in the following (FIG. 3).

$$\begin{matrix}D ( n ) = {\sum }_{j = 1}^{c} dist ( V [ n ] , {Π}_{F ( V [ n ] ) j} ) & ( 18 ) \\ {D}_{2} ( n , k ) = \{ \begin{matrix}D ( n ) & if k = F ( V [ n ] ) \\ 0 & otherwise\end{matrix} \\ {G}_{2} ( V ) = {w}_{k} ⇔ k = arg {max}_{k} {\sum }_{n = 1}^{L} {D}_{2} ( n , k ) & ( 19 )\end{matrix}$$

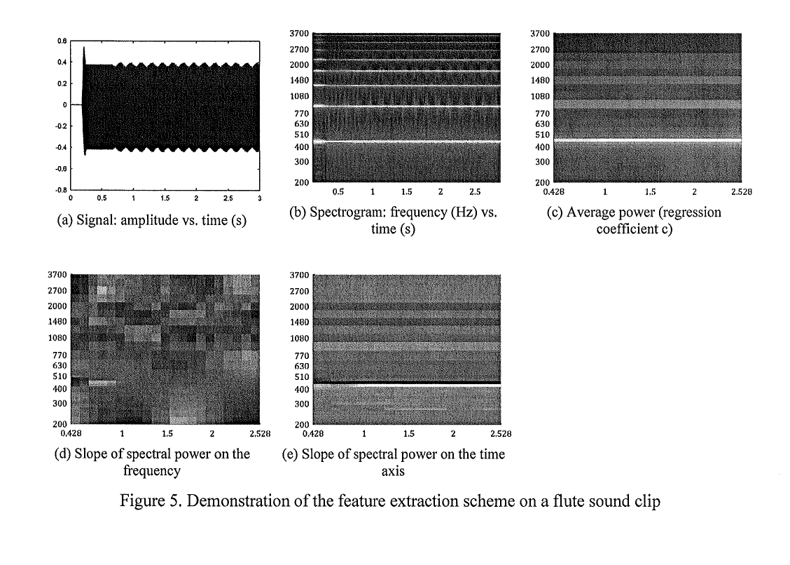

FIG. 5 demonstrates the feature extraction method on a flute sound clip. Each feature vector V is composed of 32 (from equation (9)) sets of three surface linear regression coefficients and 2 formants making the V of 98 dimensions. The first coefficient is the slope on the y-axis which corresponds to the amount of spectral power change in the frequency axis. The second coefficient is the slope on the x-axis which corresponds to the amount of spectral power change in the time axis. The third one is the z-axis offset of the plane which corresponds to the amount of spectral power in that segment, which is also equivalent to the spectrogram when it is segment-averaged. Consecutive feature vectors are generated with a period of t_{R} and assembled to represent the speech sample.

The speech sample can be pretty complex on a spectrogram; therefore to illustrate the feature extraction more clearly, a flute sound clip is used in the spectrogram. In FIG. 5a, the discrete signal of a flute sound of duration 3 sec is shown. In FIG. 5b, the spectrogram of this signal in 5a is shown. In FIGS. 5c, 5d, and 5e the three surface linear regression coefficients that are calculated from the spectrogram in 5b is shown. The graphs demonstrate the elements (21), (22), (23), (24), (25), and (26) in FIG. 2. The white colour shows a high power, therefore indicating the discriminative power of the features to be used in the next step, classification. The three two dimensional information (FIGS. 5c, 5d, and 5e) is already partitioned by the Bark scale and the time-axis parameters. The quantized values are ready to be assembled for a feature vector to be used in the Support Vector Machine classification.

Each embodiment of the invention may include, or may be implemented by electronics, which may include a processing device, processor or controller to perform various functions and operations in accordance with the invention. The processor may also be provided with one or more of a wide variety of components or subsystems including, for example, a co-processor, register, data processing devices and subsystems, wired or wireless communication links, input devices, monitors, memory or storage devices such as a database. All or parts of the system and processes can be stored on or read from computer-readable media. The system can include computer-readable medium, such as a hard disk, having stored thereon machine executable instructions for performing the processes described.

The description and drawings of the present invention provided here should be considered as illustrative only of the principles of the invention. The invention may be configured in a variety of ways and is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention. The invention may be implemented, for instance, on a mobile phone, a personal computer, a personal data assistant, a tablet computer, a touch screen computing device, a multiple processor server computer like a cluster, mainframe or server farm, a standalone and environment monitoring computer at a place with people, and the like.

Illustrative embodiments of the invention include a system and method for performing Speech Emotion Recognition (SER). The invention may include a system and method for performing local feature extraction (Short Time Fourier Transform (STFT)), signal processing, quantization of information, and sequential accumulation of feature vectors. The invention may include a system and method for performing second stage processing (e.g., majority voting or weighted-majority voting). The signal processing may incorporate the subdivision of spectrograms based on natural divisions of frequency to humans (e.g., the Bark scale).

Illustrative embodiments of the invention can include a system and method for performing any or all of the following steps: (1) Obtaining a discrete-time speech signal sample; (2) Calculating indices for performing a Short Time Fourier Transform (STFT) on a discrete-time speech signal sample; (3) Generating the STFT based on the calculated indices; (4) Calculating true power spectra of the sample in decibels; (5) Using a constant Bark scale vector to calculate an index vector; (6) Partitioning the power spectra into a plurality of partitions based on the index vector; (7) Calculating a regressed frequency-time surface at the center of each partition; (8) Setting a regression surface origin at the center of each partition; (9) Computing estimated regression coefficients by performing a least squares estimate of regression of each frequency-time surface; (10) Using the estimated regression coefficients to generate one or more feature vectors; and (11) Using the feature vectors to determine emotions corresponding to the sample. (12) Arranging the feature vectors for majority voting; (13) Arranging the feature vectors for weighted majority voting.

Illustrative embodiments of the invention can incorporate a minimum sampling time of 25 ms. The invention may incorporate feature extraction, which may be administered on a short duration (e.g., 300 ms) of a speech signal or a long duration (e.g., 1000 ms) of a speech signal. The invention may be configured to provide accuracies in prediction as set forth in the paper and the accompanying information incorporated herein.

The Speech Emotion Recognition (SER) method of the present invention is implemented using the computer language Java to be run on a computer or a mobile device with a processor, memory and long-term storage device such as hard disk or flash memory (FIG. 1). The language Java is chosen so SER is portable to almost every platform (such as mobile devices, desktop computers or servers). The software uses Java Concurrent module to be able to run multiple feature extraction processes on multiple speech samples at the same time. This way, the method can be employed on servers to accommodate multiple calls in a call-center (such as 911 call centers) or multiple streams on wireless mobile servers.

Memory architecture of the implementation uses a flat one-dimensional buffer to be used for two-dimensional spectrogram processing and output. Depending on the partitioning parameters (min 25 ms sampling on 300-1000 ms duration (i.e. 12-40 samples)) the memory usage of the spectrogram changes from a small buffer to bigger buffer. By employing a one-dimensional buffer and addressing it as a two-dimensional buffer, memory is utilized in the most efficient way.

The following Java classes are used in the SER software: Class Fv Math, Fast Fourier Transform, linear multiple regression functions; Class Jk Feature extraction, training, testing, confusion matrix calculation, majority voting, logging functions; Class Jkn Concurrent processing of Jk class, multiple processing, accumulating training and prediction functions; Class Dt File operations; Class Fvset Feature vector data structures; Class Wset Assembling feature vectors in terms of speech sample attributes, such as gender, age, native language or database tags; Class Stats Statistics functions.

The foregoing description and drawings should be considered as illustrative only of the principles of the invention. The invention may be configured in a variety of ways and is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. A method for performing local feature extraction comprising using a processing device to perform the steps of:
performing a Short Time Fourier Transform to obtain a spectrogram for a discrete-time speech signal sample;
subdividing the spectrogram based on natural divisions of frequency to humans;
quantizing time-frequency-energy information obtained from the spectrogram;
computing feature vectors based on the quantized time-frequency-energy information; and
classifying an emotion of the speech signal sample based on the computed feature vectors.

2. The method according to claim 1, wherein the step of subdividing the spectrogram comprises subdividing the spectrogram based on the Bark scale.

3. The method according to claim 1 further comprising the step of employing majority voting on the feature vectors to predict an emotion associated with the speech signal sample.

4. The method according to claim 1 further comprising the step of employing weighted-majority voting on the feature vectors to predict an emotion associated with the speech signal sample.

5. The method according to claim 1, wherein the time and the frequency information of a speech signal is transformed into a short time Fourier series and quantized by the regressed surfaces of the spectrogram.

6. The method according to claim 1, further comprising storing both the time and the frequency information together.

7. A system for performing local feature extraction comprising using a processing device to perform the steps of:
a processor configured to perform a Short Time Fourier Transform to obtain a spectrogram for a discrete-time speech signal sample;
the processor further configured to subdivide the spectrogram based on natural divisions of frequency to humans;
the processor further configured to quantize time-frequency-energy information obtained from the spectrogram;
the processor further configured to compute feature vectors based on the quantized time-frequency-energy information; and
the processor further configured to classify an emotion of the speech signal sample based on the computed feature vectors.

8. The system according to claim 7, wherein the step of subdividing the spectrogram comprises subdividing the spectrogram based on the Bark scale.

9. The system according to claim 7, the processor further configured to employ majority voting on the feature vectors to predict an emotion associated with the speech signal sample.

10. The system according to claim 7, the processor further configured to employ weighted-majority voting on the feature vectors to predict an emotion associated with the speech signal sample.

11. The system according to claim 7, the processor further configured to transform the time and the frequency information of the speech signal into a short time Fourier series and quantized by the regressed surfaces of the spectrogram.

12. The system according to claim 7, further comprising a storage device configured to store the time and the frequency information together.
